(19) United States
(12) Patent Application Publication
(10) Pub. No.: US 2023/0307697 A1
(43) Pub. Date: Sep. 28, 2023

(54) ALL-SOLID-STATE BATTERY

(71) Applicant: SAMSUNG ELECTRO-MECHANICS CO., LTD., Suwon-si, Gyeonggi-do (KR)

(72) Inventors: Young-Jin Hwang, Suwon-si, Gyeonggi-do (KR); Kyung-Lock Kim, Suwon-si, Gyeonggi-do (KR); Myung-Jin Jung, Suwon-si, Gyeonggi-do (KR)

(73) Assignee: SAMSUNG ELECTRO-MECHANICS CO., LTD., Suwon-si, Gyeonggi-do (KR)

(21) Appl. No.: 18/020,346

(22) PCT Filed: Nov. 12, 2021
(86) PCT No.: PCT/KR2021/016487

§ 371 Date: Feb. 8, 2023

(30) Foreign Application Priority Data
Dec. 31, 2020 (KR) 10-2020-0189694

(51) Int. Cl. H01M 10/0562; H01M 10/0585; H01M 4/583

(52) U.S. Cl. CPC H01M 10/0562; H01M 10/0585; H01M 4/583; H01M 2300/0065

(57) ABSTRACT

An all-solid-state battery includes a battery body having opposing first and second surfaces and opposing third and fourth surfaces, and including a positive electrode layer having at least a portion led out to the first surface, and a negative electrode layer having at least a portion led out to the second surface, a solid electrolyte interposed between the positive and negative electrode layers; a positive electrode terminal connected to the positive electrode layer and disposed on the first surface; and a negative electrode terminal connected to the negative electrode layer and disposed on the second surface. The positive and negative electrode layers each include an electrode lead led out to the third and the fourth surfaces. The positive electrode terminal has at least a portion extending on the third and fourth surfaces, and the negative electrode terminal has at least a portion extending on the third and fourth surfaces.

### TECHNICAL FIELD

The present disclosure relates to an all-solid-state battery.

### BACKGROUND ART

Recently, devices using electricity as an energy source have been increasing. With the expansion of applications of devices using electricity as an energy source, such as smartphones, camcorders, laptop PCs, electric vehicles, and the like, interest in electric storage devices using electrochemical elements is increasing. Among various electrochemical elements, lithium secondary batteries that may be charged and discharged, have a high operating voltage, and have high energy density, have come into the spotlight.

A lithium secondary battery may be manufactured by applying a material capable of intercalating and de-intercalating lithium ions into a positive electrode and a negative electrode, and injecting a liquid electrolyte between the positive electrode and the negative electrode, and electricity may be generated or consumed by the reduction or oxidation reaction of the lithium secondary battery intercalating and de-intercalating the lithium ions in the negative electrode and the positive electrode. Such a lithium secondary battery should basically be stable within the operating voltage range of the battery, and should have performance capable of transferring ions at a sufficiently high rate.

When a liquid electrolyte, such as a nonaqueous electrolyte, is used in the lithium secondary battery, discharge capacity and the energy density may be advantageously high. However, it may be difficult to implement high voltage lithium secondary batteries, and issues such as relatively high risk of electrolyte leakage, fires, and explosions may occur.

To address the above issues, a secondary battery using a solid electrolyte, rather than a liquid electrolyte, has been proposed as an alternative. The solid electrolyte may be classified as a polymer-based solid electrolyte or a ceramic-based solid electrolyte. The ceramic-based solid electrolyte is advantageous in exhibiting high stability. However, solid electrolyte batteries suffer from an issue that ionic conductivity is lowered due to high interfacial resistance and an interfacial side reaction, and an increase in utilization rate of active materials and rate determination is required.

### DISCLOSURE OF INVENTION

### Technical Problem

An aspect of the present disclosure is to provide an all-solid-state battery having excellent ionic conductivity.

Another aspect of the present disclosure is to provide an all-solid-state battery for securing sufficient capacity while being able to be miniaturized.

Another aspect of the present disclosure is to provide an all-solid-state battery having high charging and discharging rates.

### Solution to Problem

According to an aspect of the present disclosure, an all-solid-state battery includes: a battery body having first and second surfaces opposing each other in a first direction, third and fourth surfaces opposing each other in a second direction, and fifth and sixth surfaces opposing each other in a third direction, and including a solid electrolyte, a positive electrode layer having at least a portion led out to the first surface, and a negative electrode layer having at least a portion led out to the second surface, the positive and negative electrode layers being stacked in the third direction with the solid electrolyte interposed therebetween; a positive electrode terminal connected to the positive electrode layer and disposed on the first surface of the battery body; and a negative electrode terminal connected to the negative electrode layer and disposed on the second surface of the battery body. The positive electrode layer includes a positive electrode lead portion led out to the third and the fourth surfaces of the battery body, and the negative electrode layer includes a negative electrode lead portion led out to the third and fourth surfaces of the battery body. The positive electrode terminal has at least a portion disposed to extend on the third and fourth surfaces of the battery body, and the negative electrode terminal has at least a portion disposed to extend on the third and fourth surfaces of the battery body, and is spaced apart from the positive electrode terminal.

According to an aspect of the present disclosure, an all-solid-state battery includes: a battery body having first and second surfaces opposing each other in a first direction, third and fourth surfaces opposing each other in a second direction, and fifth and sixth surfaces opposing each other in a third direction, and including a solid electrolyte, a positive electrode layer having at least a portion led out to the first surface, and a negative electrode layer having at least a portion led out to the second surface, the positive and negative electrode layers being stacked in the third direction with the solid electrolyte interposed therebetween; a positive electrode terminal connected to the positive electrode layer and disposed on the first surface of the battery body; and a negative electrode terminal connected to the negative electrode layer and disposed on the second surface of the battery body. One or more of the positive electrode layer and the negative electrode layer includes an electrode lead portion led out to one or more of the third and the fourth surfaces of the battery body. The positive electrode terminal or the negative electrode terminal has at least a portion extending on the one or more of the third and fourth surfaces of the battery body to connect to the electrode lead portion.

### Advantageous Effects of Invention

As described above, ionic conductivity of an all-solid-state battery may be improved.

In addition, an all-solid-state battery, having sufficient capacity while being miniaturized, may be provided.

In addition, charging and discharging rates of an all-solid-state battery may be increased.

### BRIEF DESCRIPTION OF DRAWINGS

The above and other aspects, features, and advantages of the present disclosure will be more clearly understood from the following detailed description, taken in conjunction with the accompanying drawings.

FIG. 1 is a schematic perspective view of an all-solid-state battery according to an exemplary embodiment of the present disclosure,

FIG. 2 is a schematic perspective view of a battery body of FIG. 1.

FIG. 3 is a cross-sectional view taken along line of FIG. 1.

FIG. 4 is a schematic plan view of a positive electrode layer of a multilayer ceramic electronic component according to the present disclosure.

FIG. 5 is a schematic plan view of a negative electrode layer of a multilayer ceramic electronic component according to the present disclosure.

FIG. 6 is a schematic perspective view of a battery body according to another exemplary embodiment of the present disclosure.

FIG. 7 is a cross-sectional view of FIG. 6.

FIG. 8 is a schematic exploded perspective view illustrating a stacked form of all-solid-state batteries according to an exemplary embodiment of the present disclosure.

FIG. 9 is a plan view for comparing structures of the related art and the present disclosure.

FIG. 10 is a graph of an example and a comparative example of an all-solid-state battery according to the present disclosure.

### MODE FOR THE INVENTION

Hereinafter, embodiments of the present disclosure will be described in detail with reference to the accompanying drawings. The present disclosure may, however, be exemplified in many different forms and should not be construed as being limited to the specific embodiments set forth herein. Further, embodiments of the present disclosure may be provided for a more complete description of the present disclosure to those skilled in the art. Accordingly, the shapes and sizes of the elements in the drawings may be exaggerated for clarity of description, and the elements denoted by the same reference numerals in the drawings may be the same elements.

In order to clearly illustrate the present disclosure, portions not related to the description are omitted, and thicknesses are enlarged in order to clearly represent layers and regions, and similar portions having the same functions within the same scope are denoted by similar reference numerals throughout the specification.

In the present specification, expressions such as “have,” “may have,” “include,” “comprise,” “may include,” or “may comprise” may refer to the presence of corresponding features (for example, elements such as numbers, functions, actions, or components), and does not exclude the presence of additional features.

In the present specification, expressions such as “A and/or B,” “at least one of A and B,” or “one or more of A and B” may include all possible combinations of items listed together. For example, “A and/or B,” “at least one of A and B,” or “one or more of A and B” may refer to (1) including at least one A, (2) including at least one B, or (3) including all at least one A and at least one B.

In the drawings, an X direction may be defined as a first direction, an L direction, or a length direction, a Y direction may be defined as a second direction, a W direction, or a width direction, and a Z direction may be defined as a third direction, a T direction, or a thickness direction.

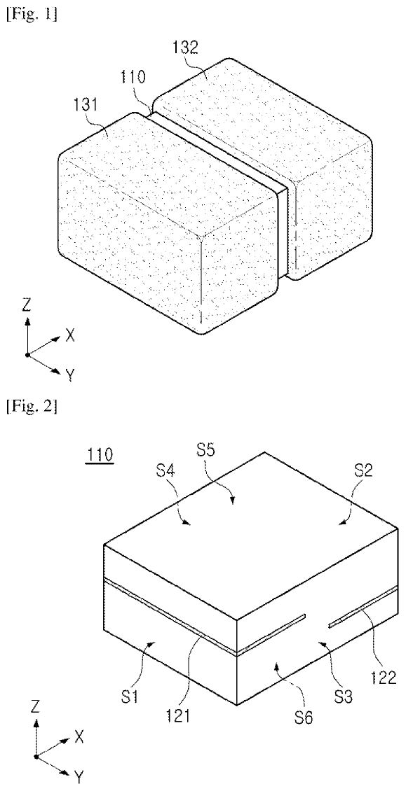

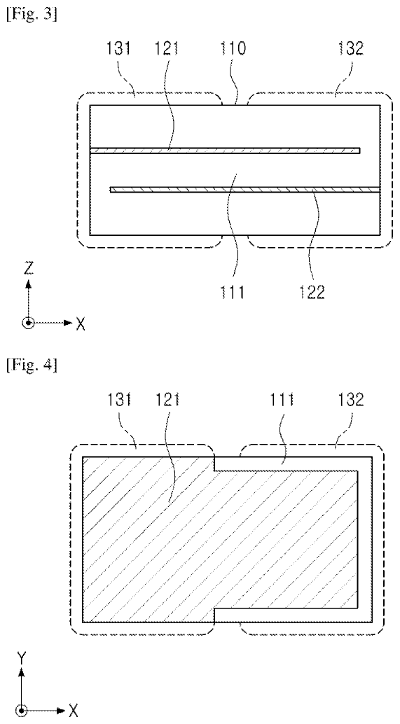

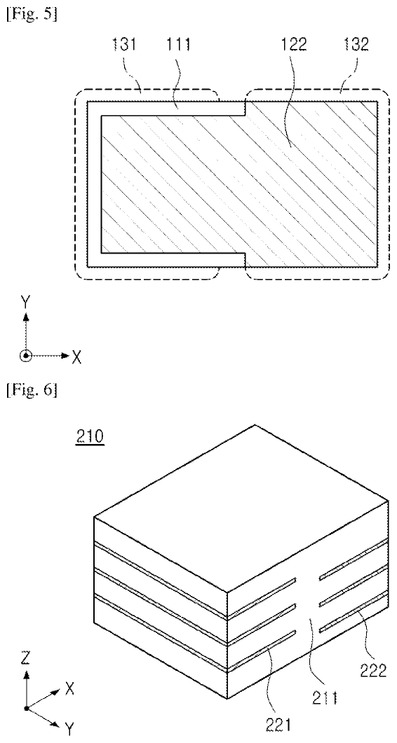

The present disclosure relates to an all-solid-state battery 100. FIGS. 1 to 5 are schematic views of an all-solid-state battery 100 according to an exemplary embodiment of the present disclosure, Referring to FIGS. 1 to 5, the all-solid-state battery 100 according to the present disclosure may include: a battery body 110 having first and second surfaces S1 and S2 opposing each other in a first direction (an X direction), third and fourth surfaces S3 and S4 opposing each other in a second direction (a V direction), and fifth and sixth surfaces S5 and S6 opposing each other in a third direction (a Z direction), and including a solid electrolyte 111, a positive electrode layer 121 having at least a portion led out to the first surface S1 of the battery body 110, and a negative electrode layer 122 having at least a portion led out to the second surface S2 of the battery body 110, the positive and negative electrode layers 121 and 122 being stacked in the third direction with the solid electrolyte 111 interposed therebetween; a positive electrode terminal 131 connected to the positive electrode layer 121 and disposed on the first surface S1 of the battery body 110; and a negative electrode terminal 132 connected to the negative electrode layer 122 and disposed on the second surface S2 of the battery body 110.

In this case, the positive electrode layer 121 may include a positive electrode lead led out to the third and the fourth surfaces S3 and S4 of the battery body 110, and the negative electrode layer 122 may include a negative electrode lead led out to the third and fourth surfaces S3 and S4 of the battery body 110. In addition, the positive electrode terminal 131 may have at least a portion disposed to extend upwardly of the third and fourth surfaces S3 and S4 of the battery body 110, and the negative electrode terminal 132 may have at least a portion disposed to extend upwardly of the third and fourth surfaces S3 and S4 of the battery body 110, and may be spaced apart from the positive electrode terminal 131.

In general, an all-solid-state battery according to the related art shown in (a) in FIG. 9 uses a structure in which an external terminal electrode is formed on a head surface of a battery body, similarly to an existing passive device. The above structure corresponds to a structure in which a positive electrode layer and a negative electrode layer are connected to an external terminal electrode through a head surface of a battery body. However, in the case of the above structure, a utilization rate of the electrode may be reduced and a charge transfer path A may be elongated. The all-solid-state battery according to the present disclosure may include a positive electrode lead portion and a negative electrode lead portion led out in both directions of the battery body in the second direction as shown in (b) in FIG. 9, and at least a portion of the positive and negative electrode terminals may be disposed to upwardly of both surfaces of the battery body in the second direction, so that the charge transfer path B may be shortened to improve ionic conductivity.

The body 110 of the all-solid-state battery 100 according to the present disclosure may include a solid electrolyte layer 111, a positive electrode layer 121, and a negative electrode layer 122.

In an exemplary embodiment of the present disclosure, the solid electrolyte layer 111 according to the present disclosure may be or include at least one selected from the group consisting of a Garnet-type solid electrolyte, a Nasicon-type solid electrolyte, a LISICON-type solid electrolyte, a perovskite-type solid electrolyte, and a LiPON-type solid electrolyte.

The Garnet-type solid electrolyte may refer to lithium lanthanum zirconium oxide (LLZO) represented by LiₐLa_{b}Zr_{c}O₁₂ such as Li₇La₃Zr₂O₁₂, and the Nasicon-type solid electrolyte may refer to lithium aluminum titanium phosphate (LATP) represented by Li₁₊ₓAlₓTi₂₋ₓ(PO₄)₃ (where 0<x<1), which is a compound of Li₁₊ₓAlₓM₂₋ₓ(PO₄)₃ (LAMP) (where 0<x<2 and M is Zr, Ti, or Ge) with Ti introduced thereinto, lithium aluminum germanium phosphate (LAGP) represented by Li₁₊ₓAlₓGe₂₋ₓ(PO₄)₃ (where 0<x<1) such as Li_{1.3}Al_{0.3}Ti_{1.7}(PO₄)₃ with an excessive amount of lithium introduced thereinto, and/or lithium zirconium phosphate (LZP) represented by LiZr₂(PO₄)₃.

The LISICON-type solid electrolyte may be represented by xLi₃AO₄-(1−x)Li₄BO₄ (where A is P, As, V, or the like, and B is Si, Ge, Ti, or the like), and may refer to a solid solution oxide, including Li₄Zn(GeO₄)₄, Li₁₀GeP₂O₁₂ (LGPO), Li_{3.5}Si_{0.5}P_{0.5}O₄, Li_{10.42}Si(Ge)_{1.5}P_{1.5}Cl_{0.08}O_{11.92}, or the like, or a solid solution sulfide represented by Li₄₋ₓM_{1-y}M′_{y}′S₄ (where M is Si or Ge, and M′ is P, Al, Zn, or Ga), including Li₂S—P₂S₅, Li₂S—SiS₂, Li₂S—SiS₂—P₂S₅, Li₂S—GeS₂, or the like.

The perovskite-type solid electrolyte may refer to lithium lanthanum titanate oxide (LLTO) represented by Li₃ₓLa_{2/3-x□1/3-2x}TiO₃ (where 0<x<0.16, □ denotes a vacancy), such as Li_{1/8}La_{5/8}TiO₃, and the LiPON-type solid electrolyte may refer to a nitride like lithium phosphorous oxynitride such as Li_{2.8}PO_{3.3}N_{0.46}.

In an example, the positive electrode layer 121 of the all-solid-state battery 100 according to the present disclosure may include a positive electrode active material and a conductive material. For example, the positive electrode layer 121 of the all-solid-state battery 100 according to the present disclosure may be an integrated positive electrode layer in which a positive electrode active material and a conductive material are mixed.

In this case, the positive active material and the conductive material of the positive electrode layer may overlap at least a portion of a region disposed in a battery body of an all-solid-state battery. This is because the all-solid-state battery according to the present disclosure uses a composite positive electrode layer having a single structure which does not use a separate positive electrode current collector. In addition, the filling amount of the positive electrode active material may be increased in proportion to a space occupied by the positive electrode current collector to contribute to an increase in battery capacity.

Examples of the positive electrode active material may be compounds represented by the following formulas: LiₐA_{1-b}M_{b}D₂ (where 0.90≤a≤1.8 and 0≤b≤0.5); LiₐE_{1-b}M_{b}O_{2-c}D_{c} (where 0.90≤a≤1.8, 0≤b≤0.5, and 0≤c≤0.05); LiE_{2-b}M_{b}O_{4-c}D_{c} (where 0≤b≤0.5 and 0≤c≤0.05); LiaNi_{1-b-c}Co_{b}M_{2-α}D_{α} (where 0.90≤a≤1.8, 0≤b≤0.5, 0≤c≤0.05, and 0≤α≤2); LiₐNi_{1-b-c}Co_{b}M_{c}O_{2-α}X_{α} (where 0.90≤a≤1.8, 0≤b≤0.5, 0≤c≤0.05 and 0<α<2); LiₐNi_{1-b-c}Co_{b}M_{c}O_{2-α}X₂ (where 0.90≤a≤1.8, 0≤b≤0.5, 0≤c≤0.05, and 0<α<2); LiₐNi_{1-b-c}Mn_{b}M_{c}D_{α} (where 0.90≤a≤0≤b≤0.5, 0≤c≤0.05, and 0<α≤2); LiₐNi_{1-b-c}Mn_{b}M_{c}O_{2-α}X_{α} (where 0.90≤a≤1.8, 0≤b≤0.5, 0≤c≤0.05, and 0<α<2); LiₐNi_{1-b-c}Mn_{b}O_{2-α}X₂ (where 0.90≤a≤1.8, 0≤b≤0.5, 0≤c≤0.05, and 0<α<2); LiₐNi_{b}E_{c}G_{d}O₂ (where 0.90≤a≤1.8, 0≤b≤0.9, 0≤c≤0.5 and 0.001≤d≤0.1); LiₐNi_{b}Co_{c}Mn_{d}GₑO₂ (where 0.90≤a≤1.8, 0≤b≤0.9, 0≤c≤0.5, 0≤d≤0.5, and 0.001≤e≤0.1); LiₐNiG_{b}O₂ (where 0.90≤a≤1.8 and 0.001≤b≤0.1); LiₐCoG_{b}O₂ (where 0.90≤a≤1.8 and 0.001≤b≤0.1); LiₐMnG_{b}O₂ (where 0.90≤a≤1.8 and 0.001≤b≤0.1); LiₐMn₂G_{b}O₄ (where 0.90≤a≤1.8 and 0.001≤b≤0.1); QO₂; QS₂; LiQS₇; V₂O₅; LiV₂O₂; LiRO₂; LiNiVO₄; Li_{(3-f)}J₂(PO₄)₃ (where 0≤f≤2); Li_{(3-f)}Fe₂(PO₄)₃ (where 0≤f≤2); and LiFePO₄, in which A is Ni, Co, or Mn; M is Al, Ni, Co, Mn, Cr, Fe, Mg, Sr, V, or a rare earth element; D is O, F, S, or P; E is Co or Mn; X is F, S, or P; G is Al, Cr, Mn, Fe, Mg, La, Ce, Sr, or V; Q is Ti, Mo, or Mn; R is Cr, V, Fe, Sc, or Y; and J is V, Cr, Mn, Co, Ni, or Cu.

The positive electrode active material may also be LiCoO₂, LiMnₓO₂ₓ (where x=1 or 2), LiNi₁₋ₓMnₓO₂ₓ (where 0<x<1), LiNi_{1-x-y}CoₓMn_{y}O₂ (where 0≤x≤0.5 and 0≤y≤0.5), LiFePO₄, TiS₂, FeS₂, TiS₃, or FeS₃, but exemplary embodiments are not limited thereto.

The conductive agent is not particularly limited as long as it has conductivity without causing a chemical change in the all solid state battery according to the present disclosure. For example, the following conductive material may be used: graphite such as natural graphite or artificial graphite; a carbon-based material such as carbon black, acetylene black, ketjen black, channel black, furnace black, lamp black, or thermal black; a conductive fiber such as a carbon fiber and a metal fiber; carbon fluoride; a metal component such as lithium (Li), tin (Sn), aluminum (Al), nickel (Ni), copper (Cu), oxide, nitride or fluorides thereof, or the like; a conductive whisker such as a zinc oxide or potassium titanate whisker; a conductive metal oxide such as a titanium oxide; or a polyphenylene derivative.

In an example of the present disclosure, the positive electrode layer of the all solid-state battery may further include a solid electrolyte component. The solid electrolyte component may use at least one of the above-mentioned components, and may function as an ion conduction channel in the positive electrode layer. Accordingly, interfacial resistance may be decreased.

In an exemplary embodiment of the present disclosure, the positive electrode layer 121 may include a positive electrode lead portion. The positive electrode lead portion may be formed by extending the positive electrode layer, and may be led out to the third and fourth surface of the battery body of the all-solid-state battery according to the present: disclosure. The positive electrode lead portion may be connected to the positive electrode terminal, and may serve to decrease a distance between an end of the positive electrode layer in a direction of the negative electrode terminal and the positive electrode terminal. Accordingly, a current loop may be reduced to improve ionic conductivity and charging and discharging rates.

When the positive electrode layer of the all-solid-state battery according to the present disclosure includes a positive electrode lead portion, the positive electrode layer may have a T-shape. The positive electrode lead portion of the positive electrode layer may be disposed on both side surfaces of the positive electrode layer in a second direction. When the positive electrode layer including the positive electrode lead portion is disposed to intersect the first surface of the battery body, the positive electrode layer may have a T-shape. The shape of the positive electrode layer may refer to a shape viewed in the third direction. When the positive electrode layer has a T-shape, an area in which the positive electrode lead is led outwardly of the battery body may be increased, and an area in which the positive electrode layer is connected to the positive electrode terminal may be increased to improve bonding strength of the positive electrode terminal.

In an example, an average length of the positive electrode lead portion of the all-solid-state battery according to the present disclosure in the first direction may be in the range of 10% or more and less than 50% of the average length of the battery body in the first direction. In the present specification, a “length” of a member may refer to a shortest vertical distance obtained by measuring the member in a direction parallel to the first direction, and an “average length” may be an arithmetic average of lengths *?*measured at 10 points arranged at regular intervals in the third direction with respect to a cut surface (an X-Z plane) passing through the center of the all-solid-state battery and cut in a direction, perpendicular to an X-axis. In the all-solid-state battery according to the present disclosure, an average length of the positive electrode lead portion in the first direction may be 10% or more of the average length of the battery body in the first direction, and thus, a charge transfer path may be effectively shortened. In addition, to prevent a short-circuit between the positive electrode terminal and the negative electrode terminal, the average length of the positive lead portion in the first direction should be less than 50% of the average length of the battery body in the first direction.

The method of forming the positive electrode layer is not limited. For example, slurry may be prepared by mixing the above-described positive electrode active material, a conductive material (including an additional solid electrolyte layer, as necessary), a binder, and the like, and may be cast on a separate support and then cured to form the positive electrode layer 121. For example, the positive electrode layer according to the present disclosure may have a structure in which a separate positive electrode current collector is not disposed, and a positive electrode active material and a conductive material (and a solid electrolyte) may be mixed to be disposed in a single layer.

The binder may be used to improve a bonding strength between the active material and the conductive agent. Examples of the binder may include polyvinylidene fluoride, polyvinyl alcohol, carboxymethylcellulose (CMC), starch, hydroxypropylcellulose, regenerated cellulose, polyvinylpyrrolidone, polytetrafluoroethylene, polyethylene, polypropylene, ethylene-propylene-diene terpolymer (EPDM), sulfonated EPDM, styrene butadiene rubber, fluorine rubber, and various copolymers, but are not limited thereto.

The negative electrode layer 122 of the all-solid-state battery 100 according to the present disclosure may include a negative electrode active material and a conductive material. For example, the negative electrode layer of the all-solid-state battery according to the present disclosure may be an integrated negative electrode layer in which the negative electrode active material and the conductive material are mixed to be disposed.

In this case, the negative active material and the conductive material of the negative electrode layer may overlap at least a portion of a region disposed in the battery body of the all-solid-state battery. This is because the all-solid-state battery according to the present disclosure uses a single-structured composite positive electrode layer which does not use a separate positive electrode current collector, and the amount of the charged positive electrode active material may increase in proportion to a space, occupied by the positive electrode current collector, to contribute to an increase in battery capacity.

The negative electrode included in the all-solid-state battery 100 according to the present disclosure may include a commonly used negative electrode active material. The negative electrode active material may be a carbon-based material, silicon, a silicon oxide, a silicon-based alloy, a silicon-carbon-based composite material, tin, a tin-based alloy, a tin-carbon composite, a metal oxide, or a combination thereof, and may include a lithium metal and/or a lithium metal alloy.

The lithium metal alloy may include lithium and metal/metalloid alloyable with lithium. Examples of the metal/metalloid alloyable lithium may be Si, Sn, Al, Ge, Pb, Bi, Sb, an Si—Y alloy (where Y is an alkali metal, an alkali earth metal, a Group 13 to 16 element, a transition metal, a rare earth element, or a combination thereof, and does not include Si), an Sn—Y alloy (where Y is an alkali metal, an alkali earth metal, a Group 13 to 16 element, a transition metal, a transition metal oxide such as a lithium titanium oxide (Li₄Ti₅O₁₂), a rare earth element, or a combination thereof, and does not include Sn), and MnOₓ (where 0<x≤2). The element Y may be Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, or combinations thereof.

In addition, the metal/metalloid oxide alloyable with lithium may be a lithium titanium oxide, a vanadium oxide, a lithium vanadium oxide, SnO₂, SiOₓ (where 0<x<2), or the like. For example, the positive electrode active material may include one or more elements selected from the group consisting of Group 13 to 1.6 elements of the periodic table of elements. Examples of the positive electrode active material may include one or more elements selected from the group consisting of Si, Ge, and Sn.

The carbon-based material may be crystalline carbon, amorphous carbon, or a mixture thereof. The crystalline carbon may be graphite such as natural graphite or artificial graphite in a shapeless, plate-like, flake, spherical, or fibrous form. In addition, the amorphous carbon may be soft carbon (low-temperature fired carbon), hard carbon, mesophase pitch carbide, fired coke, graphene, carbon black, fullerene soot, carbon nanotubes, or carbon fibers, but is not limited thereto.

The silicon may be selected from the group consisting of Si, SiOₓ, (where 0<x<2, for example 0.5 to 1.5), Sn, SnO₂, a silicon-containing metal alloy, and a mixture thereof. Examples of the silicon-containing metal alloy may include one or more of Al, Sn, Ag, Fe, Bi, Mg, Zn, In, Ge, Pb, and Ti, together with silicon.

The negative electrode layer of the all-solid-state battery 100 according to the present disclosure may use the same conductive material as the positive electrode layer. The negative electrode layer 122 may be formed by almost the same method except for use of the negative electrode active material, rather than the positive electrode active material, in the above-described process of forming the positive electrode.

In one example of the present disclosure, the negative electrode layer of the all-solid-state battery may further include a solid electrolyte component. The solid electrolyte component may use at least one of the above components, and may function as an ion conduction channel in the negative electrode layer. Accordingly, interfacial resistance may be reduced.

In one embodiment of the present disclosure, the negative electrode layer 122 according to the present disclosure may include a negative electrode lead portion. The negative lead portion may be a portion formed by extending the negative electrode layer, and may be led out to the third and fourth surfaces of the battery body of the all-solid-state battery according to the present disclosure. The negative lead portion may be connected to the negative electrode terminal, and may serve to reduce a distance between an end of the negative electrode layer in a direction of the positive electrode terminal and the negative electrode terminal. Accordingly, a current loop may be reduced to increase ionic conductivity and charging and discharging rates.

When the negative electrode layer of the all-solid-state battery according to the present disclosure includes a negative lead portion, the negative electrode layer may have a T-shape. The negative electrode lead portion of the negative electrode layer may be disposed on both side surfaces of the negative electrode layer in the second direction. When the negative electrode layer including the negative electrode lead portion is disposed to intersect the first surface of the battery body, the negative electrode layer may have a T-shape. The shape of the negative electrode layer may refer to a shape viewed in the third direction. When the negative electrode layer has a T-shape, an area in which the negative lead portion is lead outwardly of the battery body may be increased, and an area in which the negative electrode layer is connected to the negative electrode terminal may be increased to improve bonding strength of the negative electrode terminal.

In one example, an average length of the negative lead portion of the all-solid-state battery according to the present disclosure in the first direction may be in the range of 10% or more and less than 50% of the average length of the battery body in the first direction. In the all-solid-state battery according to the present disclosure, an average length of the negative lead portion in the first direction may be 1.0% or more of the average length of the battery body in the first direction, and thus, a charge transfer path may be effectively shortened. In addition, to prevent a short-circuit between the positive electrode terminal and the negative electrode terminal, the average length of the negative lead portion in the first direction should be less than 50% of the average length of the battery body in the first direction.

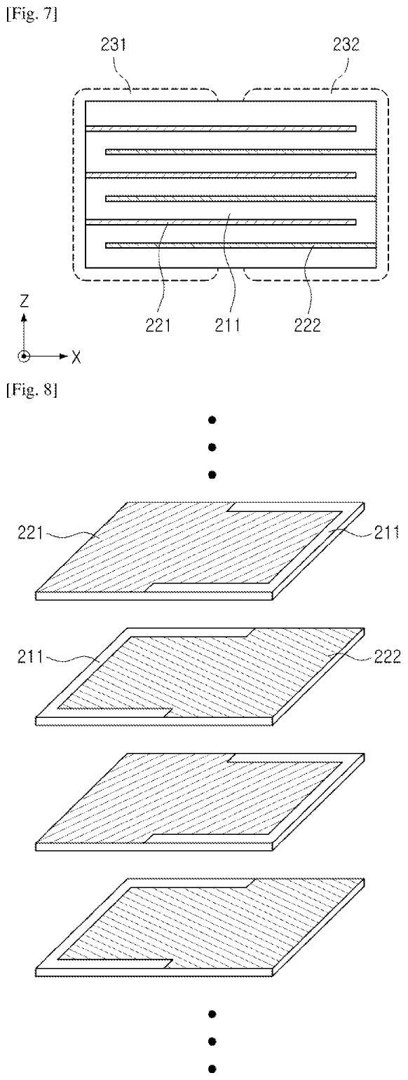

In another example of the present disclosure, the battery body of the all-solid-state battery according to the present disclosure may include a plurality of positive electrode layers and/or a plurality of negative electrode layers. FIGS. 6 and 7 are schematic views of an all-solid-state battery according to the present example. Referring to FIGS. 6 and 7, the all-solid-state battery according to the present disclosure may include two or positive electrode layers 221 and tow or more negative electrode layers 222. The positive electrode layers 221 and the negative electrode layers 222 may be alternately stacked with respectively electrolyte layers 211 interposed therebetween. When the two or more positive electrode layers 221 and/or the two or more negative electrode layers 222 are disposed as in the present example, high Charging and discharging rates and high capacity may be implemented.

The all-solid-state battery according to the present disclosure may include a positive electrode terminal 131, connected to the positive electrode layer and disposed on the first surface of the battery body, and a negative electrode terminal 132 connected to the negative electrode layer and disposed on the second surface of the battery body. A portion of the positive electrode terminal 131 may be disposed on the first surface S1 of the battery body, and at least a portion of the positive electrode terminal 131 may be disposed to extend upwardly of the third surface S3 and the fourth surface S4 of the battery body. In addition, a portion of the negative electrode terminal. 132 may be disposed on the second surface S2 of the battery body, and at least a portion of the negative electrode terminal 132 may be disposed to extend upwardly of the third surface S3 and the fourth surface S4 of the battery body, in this case, the positive electrode terminal. 131 and the negative electrode terminal 132 may be disposed to be spaced apart from each other.

In an example of the present disclosure, the positive electrode terminal 131 of the all-solid-state battery may be disposed to cover the entire positive lead portion, and the negative electrode terminal 132 may be disposed to cover the entire negative lead portion. Each of the positive lead portion and the negative lead portion may be led out to three surfaces of the battery body, as described above. The positive electrode terminal 131 may be disposed to cover all surfaces of the positive lead portion led out to the first, third, and fourth surfaces S1, S3, and S4 of the battery body, and the negative electrode terminal 132 may be disposed to cover all surfaces of the negative lead portion led out to the second, third, and fourth surface S2, S3, and S4 of the battery body. The positive and negative electrode terminals 131 and 132 may be arranged to cover the positive and negative lead portions, respectively, so that the positive and negative layers may not be exposed outwardly of the all-solid-state battery according to the present disclosure and permeation of external moisture, or the like, may be prevented.

As an example, the positive electrode layer of the all-solid-state battery according to the present disclosure may be connected to the positive electrode terminal on an edge (or a corner) at which the first and third surfaces of the battery body intersect each other and/or on an edge (or a corner) at which the first and fourth surfaces intersect each other. In addition, the negative electrode layer may be connected to an edge (or a corner) at which the second surface and the third surface of the battery body intersect each other and/or on an edge (or a corner) at which the second surface and the fourth surface intersect each other. The clause “the positive electrode layer is disposed on an edge at which the first surface and the third surface intersect each other and/or an edge at which the first and fourth surfaces of the battery body intersect each other” may mean that the positive electrode lead portion included in the positive electrode layer is disposed to the edge at which the first and third surfaces of the battery body intersect each other and/or an edge at which the first and fourth surfaces of the battery body intersect each other. When the positive electrode layer and/or the negative electrode layer of the all-solid-state battery according to the present disclosure are disposed as described above, a contact area with the positive electrode terminal and/or the negative electrode terminal may be increased to improve the bonding force of the positive electrode terminal and/or the negative electrode terminal.

The positive electrode terminal 131 and the negative electrode terminal 132 may be formed by, for example, applying a terminal electrode paste including a conductive metal to the positive electrode layer and the negative electrode layer. Alternatively, the positive electrode terminal 131 and the negative electrode terminal 132 may be formed by applying an electrode terminal paste or powder to the positive electrode layer and the negative electrode layer of a fully sintered battery body 110 and then sintering the paste or powder. The conductive metal may include or be at least one of, for example, copper (Cu), nickel (Ni), tin (Sit), palladium (Pd), platinum (Pt), gold (Au), silver (Ag), tungsten (W), titanium (Ti), lead (Pb), and alloys thereof, but example embodiments are not limited thereto.

As an example, the all-solid-state battery 100 according to the present disclosure may further include plating layers (not illustrated), respectively disposed on the first external electrode 131 and the second external electrode 132. The plating layer may include at least one selected from the group consisting of copper (Cu), nickel (Ni), tin (Sri), palladium (Pd), platinum (Pt), gold (Au), silver (Ag), tungsten (W), titanium (Ti), lead (Pb), and alloys thereof, but example embodiments are not limited thereto. The plating layer may be formed in a single layer or a plurality of layers, and may be formed by sputtering or electric deposition, but example embodiments are not limited thereto.

### Experimental Example

A solid electrolyte layer sheet was prepared by applying a paste for forming a solid electrolyte, including Li_{1.5}Al_{0.5}Ge_{1.5}(PO₄)₃(LAGP) as an electrolyte, to a carrier film and then drying the paste for forming a solid electrolyte. An electrode sheet was prepared by applying a paste for forming an electrode, including Li₃V₃(PO₄)₃(LVP) as an active material and a weight portion such as LAGP as an electrolyte and using carbon as a conductive material, on the prepared sold electrolyte layer sheet and then drying the paste for forming an electrode. The solid electrolyte sheet and the electrode sheet were stacked and then thermally treated to form a battery body having a length of 1 cm and a width of 1 cm. Terminal electrodes were formed on a first surface and a second surface of the battery body to manufacture an all-solid-state battery according to a comparative example.

A prototype battery according to an example was manufactured in the same manner as the battery according to a comparative example, except that a sheet for forming an electrode layer was applied to be led to a third surface and a fourth surface of a battery body and terminal electrodes were formed on a third surface and a fourth surface of the battery body. A length of the terminal electrode was adjusted to be about 30% of a length of the battery body.

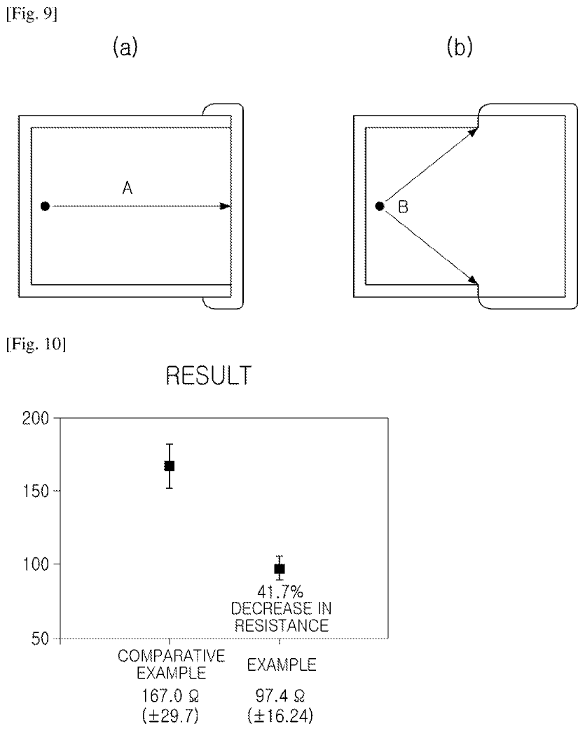

FIG. 10 illustrates resistances measured, using an LCR meter for 100 batteries according to the comparative example and the example, at 1 kHz in central portions of positive electrode terminals and negative electrode terminals of the batteries according to the comparative example and the example. As can be seen in FIG. 10, an all-solid-state battery according to the example had about 41.7% of the resistance reduction effect, as compared with an all-solid-state battery according to the comparative example. Accordingly, it can be confirmed that the all-solid-state battery according to the present disclosure has higher ionic conductivity and lower resistance than a battery structure according to the related art.

While exemplary embodiments have been shown and described above, it will be apparent to those skilled in the art that modifications and variations could be made without departing from the scope of the present disclosure as defined by the appended claims.

1. An all-solid-state battery comprising:
a battery body having first and second surfaces opposing each other in a first direction, third and fourth surfaces opposing each other in a second direction, and fifth and sixth surfaces opposing each other in a third direction, and including a solid electrolyte, a positive electrode layer having at least a portion led out to the first surface, and a negative electrode layer having at least a portion led out to the second surface, the positive and negative electrode layers being stacked in the third direction with the solid electrolyte interposed therebetween;
a positive electrode terminal connected to the positive electrode layer and disposed on the first surface of the battery body; and
a negative electrode terminal connected to the negative electrode layer and disposed on the second surface of the battery body,
wherein the positive electrode layer includes a positive electrode lead portion led out to the third and the fourth surfaces of the battery body,
the negative electrode layer includes a negative electrode lead portion led out to the third and fourth surfaces of the battery body,
the positive electrode terminal has at least a portion disposed to extend on the third and fourth surfaces of the battery body, and
the negative electrode terminal has at least a portion disposed to extend on the third and fourth surfaces of the battery body, and is spaced apart from the positive electrode terminal.

2. The all-solid-state battery of claim 1, wherein each of the positive electrode layer and the negative electrode layer has a T-shape.

3. The all-solid-state battery of claim 1, wherein the positive electrode layer is connected to the positive electrode terminal on an edge, at which the first surface and the third surface of the battery body intersect each other, and/or an edge at which the first surface and the fourth surface of the battery body intersect each other, and
the negative electrode layer is connected to the negative electrode terminal on an edge, at which the second surface and the third surface of the battery body intersect each other, and/or an edge at which the second surface and the fourth surface of the battery body intersect each other.

4. The all-solid-state battery of claim 1, wherein the positive electrode terminal is disposed to cover an entirety of the positive electrode lead portion, and
the negative electrode terminal is disposed to cover an entirety of the negative electrode lead portion.

5. The all-solid-state battery of claim 1, wherein an average length of the positive electrode lead portion is within a range of 10% or more and less than 50% of an average length of the battery body in the first direction.

6. The all-solid-state battery of claim 1, wherein an average length of the negative lead portion in the first direction is within a range of 10% or more and less than 50% of an average length of the battery body in the first direction.

7. The all-solid-state battery of claim 1, wherein the positive electrode layer includes a positive electrode active material and a conductive material, and
the negative layer includes a negative active material and a conductive material.

8. The all-solid-state battery of claim 7, wherein the positive electrode active material and the conductive material overlap at least a portion of a region disposed in the battery body, and
the negative active material and the conductive material overlap at least a portion of a region disposed in the battery body.

9. The all-solid-state battery of claim 7, wherein the positive electrode layer further includes a solid electrolyte.

10. The all-solid-state battery of claim 7, wherein the negative electrode layer further includes a solid electrolyte.

11. The all-solid-state battery of claim 1, wherein the battery body includes a plurality of positive electrode layers and a plurality of negative electrode layers.

12. The all-solid-state battery of claim 11, wherein the plurality of positive electrode layers and the plurality of negative electrode layers are alternately stacked.

13. An all-solid-state battery comprising:
a battery body having first and second surfaces opposing each other in a first direction, third and fourth surfaces opposing each other in a second direction, and fifth and sixth surfaces opposing each other in a third direction, and including a solid electrolyte, a positive electrode layer having at least a portion led out to the first surface, and a negative electrode layer having at least a portion led out to the second surface, the positive and negative electrode layers being stacked in the third direction with the solid electrolyte interposed therebetween;
a positive electrode terminal connected to the positive electrode layer and disposed on the first surface of the battery body; and
a negative electrode terminal connected to the negative electrode layer and disposed on the second surface of the battery body,
wherein one or more of the positive electrode layer and the negative electrode layer includes an electrode lead portion led out to one or more of the third and the fourth surfaces of the battery body, and
the positive electrode terminal or the negative electrode terminal has at least a portion extending on the one or more of the third and fourth surfaces of the battery body to connect to the electrode lead portion.

14. The all-solid-state battery of claim 13, wherein the electrode lead portion is led out to a corner of the battery body, and
the positive electrode terminal or the negative electrode terminal covers the corner of the battery body.

15. The all-solid-state battery of claim 13, wherein the positive electrode terminal or the negative electrode terminal covers an entirety of the electrode lead portion.

16. The all-solid-state battery of claim 13, wherein an average length of the lead portion in the first direction is within a range of 10% or more of an average length of the battery body in the first direction.

17. The all-solid-state battery of claim 16, wherein the average length of the lead portion in the first direction is within the range of 10% or more and less than 50% of the average length of the battery body in the first direction.

18. The all-solid-state battery of claim 13, wherein the positive electrode layer includes a positive electrode active material and a conductive material, and
the negative layer includes a negative active material and a conductive material.

19. The all-solid-state battery of claim 18, wherein the positive electrode layer further includes a solid electrolyte, and
the negative electrode layer further includes a solid electrolyte.

20. The all-solid-state battery of claim 13, wherein the battery body includes a plurality of positive electrode layers and a plurality of negative electrode layers alternatively disposed.
